(19) United States
(12) Patent Application Publication
(10) Pub. No.: US 2006/0033442 A1
(43) Pub. Date: Feb. 16, 2006

(54) High efficiency LED driver

(76) Inventor: Kevin P. D'Angelo, Santa Clara, CA (US)

Correspondence Address: ADVANCED ANALOGIC TECHNOLOGIES, 830 EAST ARQUES AVE, SUNNYVALE, CA, 94085, US

(21) Appl. No.: 10/916,267

(22) Filed: Aug. 11, 2004

(51) Int. Cl. H05B 37/00

(52) U.S. Cl. 315/86

(57) ABSTRACT

An LED driver includes a current sink positioned to control the flow of current between a battery and an LED. The LED driver also includes a charge pump. A control circuit monitors the forward voltage of the LED. A second voltage (V_{TRIP}) is derived to predict the voltage required to operate the current sink. Battery mode operation is used whenever the battery voltage is sufficient to supply the combination of the V_{TRIP} voltage, the LED forward voltage and a small safety margin. Charge pump mode operation is used in all other cases. The selection between battery mode and charge pump mode is dynamic, reflecting the battery's current output level as well as the brightness level of the LED.

### TECHNICAL FIELD OF THE INVENTION

The present invention relates to drivers used to power light emitting diodes (LEDs) and other devices. More particularly, the present invention relates to efficient drivers for LED applications in portable electronic systems.

### BACKGROUND OF THE INVENTION

Extending battery life is one of the most important tasks faced by designers of portable electronic systems. This is particularly true for consumer electronics, such as cellular phones, digital cameras, portable computers and other handheld equipment. Designers of these products are faced with a continual need to reduce package size (and battery size) while increasing battery life to match or exceed competitive products.

Light emitting diodes (LEDs) are commonly used in portable electronic systems. They are used to backlight LCDs for example, and to form pixels in field sequential displays. LEDs are also used to provide flash illumination (strobes) for some digital cameras and to perform a wide range of other duties. Operating these LEDs from a battery source is not entirely straightforward. This is because the forward voltage of LEDs is often higher than the voltage available from common battery chemistries and configurations. This is particularly true as a battery discharges and its output voltage falls. LED forward voltage also increases as a function of forward current. This means that battery driven LEDs are often limited to less than full brightness (since increasing their brightness requires increasing forward current and forward voltage).

As a result, some form of driver is typically used to regulate voltage and current whenever LEDs are powered by batteries. The relatively large amount of current handled by drivers of this type makes their efficiency a critical consideration for designers of portable electronic systems. As shown in FIG. 1, a typical LED driver places the LED between a charge pump and a current sink. The current sink is controlled by varying the voltage on the input labeled “V_{ISET}.” Increasing the V_{ISET} voltage increases the current draw by the current sink and, in turn increases the LED forward current. Decreasing the V_{ISET} voltage has the opposite effect.

The charge pump in FIG. 1 is used to boost battery voltage to a level sufficient for the series combination of the LED and current sink. Since the current sink is less than perfectly efficient, it is desirable to disable the charge pump whenever possible. For this reason, the LED driver operates in two modes: battery mode (where the charge pump is disabled) and charge pump mode (where the charge pump is active). Battery mode is used when battery voltage exceeds the voltage requirements of the LED and current sink. Otherwise, charge pump mode is used. To select between modes, the LED driver compares the voltage available to the current sink (i.e., the battery voltage minus the LED forward voltage). If that voltage is falls below a reference voltage (V_{REF}), charge pump mode operation is selected.

A drawback to the scheme is the fact that the reference voltage (V_{REF}) is fixed. Its value is selected using a worst case analysis that assumes that the LED is operating at full brightness. As a result, when the LED is operating at less than full brightness, charge pump mode operation is initiated earlier (i.e., at a higher battery voltage) than is actually required for operation of the LED and current sink. This decreases efficiency of the LED driver and reduces battery life.

As the preceding paragraphs describe, available LED drivers have known disadvantages and there is a need for drivers that provide greater efficiency. This need is particularly relevant to portable electronic systems where increased efficiency is directly related to increased battery life.

### SUMMARY OF THE INVENTION

The present invention provides an LED driver with enhanced efficiency. A representative implementation of the LED driver includes a current sink positioned to control the flow of current between a battery and an LED. The LED driver also includes a charge pump that may be activated to boost the output of the battery. A control circuit monitors the forward voltage of the LED. A second voltage (V_{TRIP}) is derived to predict the voltage required to operate the current sink. Battery mode operation is used whenever the battery voltage is sufficient to supply the combination of the V_{TRIP} voltage, the LED forward voltage and a small safety margin. Charge pump mode operation is used in all other cases. The selection between battery mode and charge pump mode is dynamic, reflecting battery voltage as well as the brightness level of the LED.

### BRIEF DESCRIPTION OF THE DRAWINGS

FIG. 1 is a block diagram of a prior art LED driver.

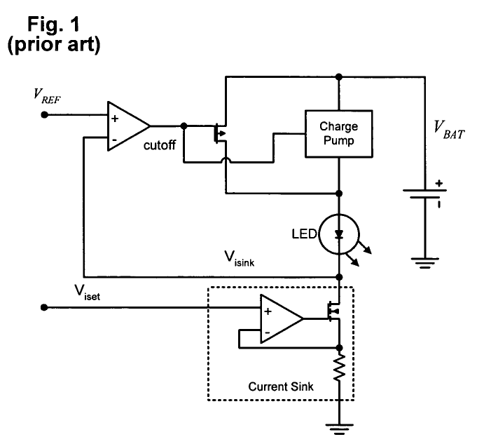

FIG. 2 is a block diagram of an LED driver as provided by an embodiment of the present invention.

FIG. 3 is a block diagram of an LED driver as provided by an embodiment of the present invention.

### DETAILED DESCRIPTION OF THE PREFERRED EMBODIMENTS

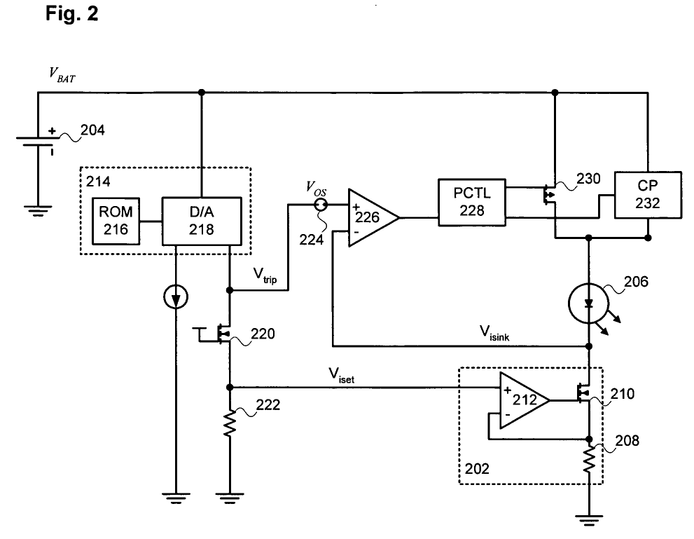

The present invention provides an LED driver with enhanced efficiency. As shown in FIG. 2, a representative implementation of the LED driver includes a current sink 202 positioned to control the flow of current between a battery 204 and an LED 206. Current sink 202 includes a resistor 208, a transistor 210 (a MOSFET in this case) and an amplifier 212. Resistor 208 is connected between the source of transistor 210 and ground. This means that the voltage over resistor 208 is proportional to the current flowing through current sink 202. This voltage is feed back to amplifier 212. The second input to amplifier 212 is a voltage V_{ISET}. Amplifier 212 regulates V_{ISET} to the voltage over resistor 208 by controlling the gate of transistor 210. As a result, the gain of transistor 210 is adjusted so that the voltage over resistor 208 is adjusted to match the V_{ISET} voltage (assuming that the voltage available at the drain of transistor 210 is at least as high as the V_{ISET} voltage). In this way, the V_{ISET} voltage controls the current passing through current source 202. In turn, the current passing through LED 206 and the brightness of LED 206 are both controlled.

To generate the V_{ISET} voltage, this particular implementation uses a variable output current source 214 that includes a read-only memory (ROM) 216 and a digital to analog converter 218. ROM 216 includes sixteen locations each of which is six bits wide. The locations in the ROM 216 are initialized to form a logarithmic scale. The output of ROM 216 is the input of digital to analog converter 218. Selecting a particular location in ROM 216 sends that value to digital to analog converter 218. In response, digital to analog converter 218 creates a corresponding current.

The output of current source 214 passes to ground through a series combination of a transistor 220 and a resistor 222. Transistor 220 (another MOSFET for this implementation) has its gate input tied high. The V_{ISET} voltage is sampled between transistor 220 and resistor 222. A second voltage V_{TRIP} is sampled between variable output current source 214 and transistor 220. The trip voltage is boosted by a voltage source 224 before being supplied to a comparator 226. The second input to comparator 226 is a V_{ISINK} voltage that is sampled between LED 206 and current sink 202.

The output of comparator 226 drives a power and control module 228. In turn, power and control module drives two outputs. One of these outputs drives a transistor 230. Power and control module 228 uses transistor 230 as a switch to connect LED 206 directly to the output of battery 204. The second output of power and control module 228 is connected to a charge pump 232. Power and control module 228 activates charge pump 232 (which may be 1.5, 2.0 or some other charge pump multiplication configuration) to boost the output of battery 204 for use by LED 206.

During operation, the brightness of LED 206 is controlled by current source 214. For this purpose, the LED driver typically exposes some interface that allows a master device to control current source 214. An example of a suitable interface is described in U.S. Patent Application Publication Number U.S. 2003-0188202 A1 (the disclosure of which is incorporated in this document by reference). For each selected brightness level, the interface chooses the corresponding location within ROM 216. Digital to analog converter 218 then produces a corresponding current.

The current produced by digital to analog converter 218 (i.e., the output of current source 214) is converted to the voltage V_{ISET} by the combination of transistor 220 and resistor 222. For this analysis, it is safe (at least initially) to ignore the effect of transistor 220 and assume that V_{ISET} is directly proportional to the current produced by digital to analog converter 218 and the value of resistor 222. The function of transistor 220 is described below.

The V_{ISET} voltage drives current sink 202. Changes to V_{ISET} change the current passing through current sink 202 and alter the brightness of LED 206. In a typical implementation, this means that a master device uses this mechanism to control the brightness of LED 206 using the interface exposed by the LED driver. This control is typically dynamic—with the brightness being increased or decreased from time to time or even varied on a continuous basis.

The V_{ISINK} voltage monitors the voltage available to current sink 202. This voltage is a function of the voltage available from battery 204 and the forward voltage of LED 206. Both of these quantities tend to change over time—the battery voltage decreases as battery 204 discharges and the forward voltage of LED 206 changes as the brightness of LED 206 is changed. Comparator 226 compares the V_{ISINK} voltage to the V_{TRIP} voltage produced by current source 214. As the voltage of battery 204 decreases, or the forward voltage of LED 206 increases, V_{ISINK} begins to approach V_{TRIP}. If the contribution of voltage source 224 is ignored, V_{ISINK} equals V_{TRIP} at the point where the forward voltage of LED 206 and the voltage required to operate current sink 202 (at the currently selected brightness level) are equal to the voltage of battery 204. Voltage source 224 makes a slight adjustment to V_{TRIP} so that the point of equivalence is reached when the battery voltage is slightly greater than the combined requirements of current sink 202 and LED 206. Otherwise, the voltage at V_{ISINK} will decrease to the point where amplifier 212 goes out of regulation, V_{ISET} will no longer be presented across resistor 208, the intended current level of current sink 202 will decrease.

At the point of equivalence, the output of comparator 226 causes PCTL 228 to activate charge pump 232 to boost the output of battery 204. In this way, the LED driver dynamically monitors the battery voltage and the requirements of current sink 202 and LED 206 to select either battery mode or charge pump mode operation. Charge pump mode is selected whenever the output of battery 204 is too low to support the operation of current sink 202 at the currently selected brightness level (with a small safety margin provided by voltage source 224).

In general, for current sinks of the type shown in FIG. 2, the drive voltage (V_{ISET}) is replicated as the voltage over the resistor 208. V_{ISINK} differs from that voltage (V_{ISET}) because of the voltage drop over transistor 210. Similarly, V_{TRIP} differs from V_{ISET} because of a voltage drop over transistor 220. In this way, transistor 220 mirrors the effect of transistor 208 and allows V_{TRIP} to more accurately predict the minimum value for V_{ISINK}. In implementations where this increased efficiency is not required, transistor 220 may be eliminated or replaced with a resistor.

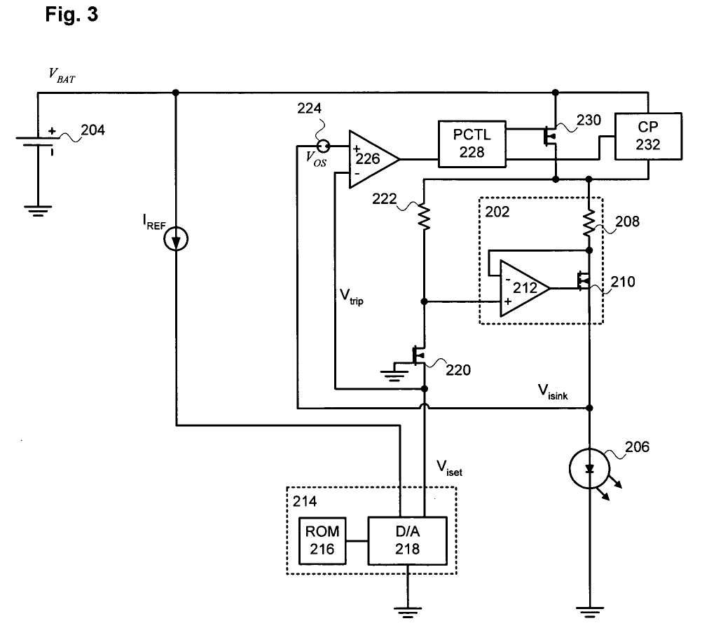

In general, it should be appreciated that the implementation shown in FIG. 2 is entirely representative in nature. In particular, it should be noted that there are a wide range of implementations for variable current source 214. Current source 214 may also be replaced with a voltage source with appropriate adjustments to the derivation of V_{TRIP}. It is also possible to replace current sink 202 with a current source positioned upstream of LED 206. A configuration of this type is shown in FIG. 3. It is also possible to employ the same mechanism for other types of boost converters in addition to the charge pumps shown in FIGS. 2 and 3.

What is claimed is:

1. A method for operating a light emitting diode (LED), the method comprising:
supplying power from a battery to the LED;
regulating the current passing through the LED to maintain the LED at a selected brightness level; and
activating a boost regulator when the battery voltage is approaching a point that is insufficient to supply the combination of the LED forward voltage and the voltage required to maintain the LED forward current at the selected brightness level.

2. A method as recited in claim 1 that further comprises: activating the boost regulator as a function of the battery voltage, the LED forward voltage and a trip voltage, where the trip voltage is proportional to the selected brightness level.

3. A method as recited in claim 1 that further comprises: monitoring an input signal to dynamically adjust the selected brightness level.

4. A method as recited in claim 1 in which the LED forward current is regulated using a current sink.

5. A method as recited in claim 1 in which the LED forward current is regulated using a current source.

6. A method for operating a light emitting diode (LED) in which the point at which a boost regulator is activated is dynamically adjusted based on the brightness level at which the LED is operating.

7. A method as recited in claim 1 wherein the boost regulator is a charge pump.

8. An apparatus for operating a light emitting diode (LED), the apparatus comprising:
a current regulator connected to control the LED forward current, the current regulator configured so that the LED brightness is selectable;
a boost regulator connected boost the output of a battery; and
a control circuit configured to activate the boost regulator when the battery voltage is approaching a point that is insufficient to supply the combination of the LED forward voltage and the voltage required to maintain the LED forward current at the selected brightness level.

9. An apparatus as recited in claim 8 in which the control circuit is configured to activate the boost regulator as a function of the battery voltage, the LED forward voltage and a trip voltage, where the trip voltage is proportional to the selected brightness level.

10. An apparatus as recited in claim 8 in which the current regulator is configured to monitor an input signal to dynamically adjust the selected brightness level.

11. An apparatus as recited in claim 8 in which the current regulator is a current sink.

12. An apparatus as recited in claim 8 in which the current regulator is a current source.

13. An apparatus as recited in claim 8 in which the boost regulator is a charge pump.
